(19) United States
(12) Patent Application Publication
(10) Pub. No.: US 2018/0225291 A1
(43) Pub. Date: Aug. 9, 2018

(54) Identifying Documents

(71) Applicant: Hewlett-Packard Development Company, L.P., Fort Collins, CO (US)

(72) Inventors: Helen Balinsky, Bristol (GB); Boris Dadachev, Bristol (GB); Steven J. Simske, Ft. Collins, CO (US); Alexander Balinsky, Cardiff (GB)

(21) Appl. No.: 15/749,449

(22) PCT Filed: Aug. 21, 2015
(86) PCT No.: PCT/US2015/046324

§ 371 Date: Jan. 31, 2018

(51) Int. Cl. G06F 17/30

(52) U.S. Cl. CPC G06F 17/3053; G06F 17/30011

(57) ABSTRACT

Examples associated with identifying documents are disclosed. One example includes identifying at least one document in a corpus of documents that contains at least one token. The token is identified from a search query. Relevance of the search query to each identified document is determined according to a Helmholtz score for each respective identified token.

### BACKGROUND

Identifying relevant information in a collection of documents is a challenge. In an enterprise or web-based environment, for example, it may be necessary to provide a means for identifying from a corpus of documents information that is most relevant to a user search query, and it is not always easy to achieve a desired result efficiently.

### BRIEF DESCRIPTION OF THE DRAWINGS

Various features and advantages of the present disclosure will be apparent from the detailed description which follows, taken in conjunction with the accompanying drawings, which together illustrate, by way of example only, features of the present disclosure, and wherein:

FIG. 1 is a schematic block diagram of a system for determining a relevance of a set of documents to a search query according to an example;

FIG. 2 is a schematic block diagram of an apparatus for determining the relevance of a set of documents based on pre-computed values according to an example;

FIG. 3 is a schematic block diagram showing an exemplary computation by a relevance determination module, according to an example;

FIG. 4 is a flow diagram of a method of determining relevance of a set of documents to a search query according to an example;

FIG. 5 is a flow diagram of a method of comparing a value to a threshold value according to an example;

FIG. 6 is a flow diagram of a method of determining values indicative of the relevance of documents to a search query based on pre-computed Helmholtz scores according to an example.

FIG. 7 is a schematic block diagram of an exemplary computer system.

### DETAILED DESCRIPTION

In the following description, for purposes of explanation, numerous specific details of certain examples are set forth. Reference in the specification to “an example” or similar language means that a particular feature, structure, or characteristic described in connection with the example is included in at least that one example, but not necessarily in other examples.

Determining the relevance of a document to a user's search query in a web based or enterprise environment is a problem for users and data providers. If users have access to a corpus of documents held in a repository the provider needs to supply a system which is capable of processing user's search queries, identifying the keywords in those queries, providing a means for identifying relevant documents for the keywords in the query and presenting the results which highlight the most and perhaps the least relevant documents to the user.

Traditional approaches to addressing such challenges have relied on techniques such as identifying similarities and dissimilarities between documents and determining probabilistic classes of documents based on those similarities. Efficient information retrieval based on classification techniques relies on the premise that documents in the same class or “cluster” will behave similarly to other documents in that cluster. Consequently, a particular request for information can be pre-processed and the most relevant cluster of documents can be identified for that query, narrowing down the scope of the information retrieval problem. A problem with this approach is that it requires time consuming and expensive pre-processing of the document corpora to determine the similarity of documents prior to any information retrieval taking place. Moreover clustering assumes properties of the underlying data such as that there should be similarities between documents containing similar strings. However, this need not be the case. For example, in the case where documents comprise files of computer code, similarity of strings between two documents may not be an indication that the two documents should be placed in the same cluster for the purpose of information retrieval as the code may relate to two or more entirely different programs (irrespective of the fact that the two programs will most likely contain many instances of the same programming language commands).

An approach to addressing these problems according to examples herein is to provide a system which assigns a “relevance score” to each document in a corpus of documents per-token (where there may be one or more than one token) where a token may comprise a string or a substring of a string representing a user's search query. The systems and methods described herein may process a search query comprising a string of characters, where the string is composed of one or more substrings. A token may be derived from a substring of a search query. For example, the token may be the substring in one case, or may be a synonym of the word represented by the substring. Each token may, for example, be a word. According to an example, for each token in the search query a value indicative of the relevance of the document is determined. In one case, computing the values for all identifiable tokens allows the system to provide an indication of how relevant a document may be to the search query. In one case, the “Helmholtz score” for a token is used as the basis for determining the relevance of a document to a search query. The Helmholtz score is a quantity which depends on the number of occurrences of the token in the document and also on the number of occurrences of the token throughout all of the documents in the corpus of documents. The Helmholtz score provides an indication of whether a particular number of occurrences of the token was an expected or unexpected event for that document in relation to the other documents. So, for example, if the token was a substring occurring a large number of times across a small number of documents, the Helmholtz score for a “typical” document may not be very large—this is because it is not an unexpected event to find, for a document chosen at random from the set of documents, a large number of occurrences of that substring. However, if the number of occurrences of the substring is large in a particular document when in other documents the overall number of occurrences of the substring is small then this is an unexpected event. Consequently the Helmholtz score will be large for that substring and document. Thus, the Helmholtz score provides a statistical measure of an unusually high occurrence of a substring within a document, and consequently, an indication that that document is relevant to the search query. In one case, the relevance of a document to a search query may be determined in relation to a subset of documents in a corpus. For example, if a corpus of documents comprises a number of separate repositories then it is possible to determine the relevance of documents in the repository to the search query in relation to other documents held in that repository.

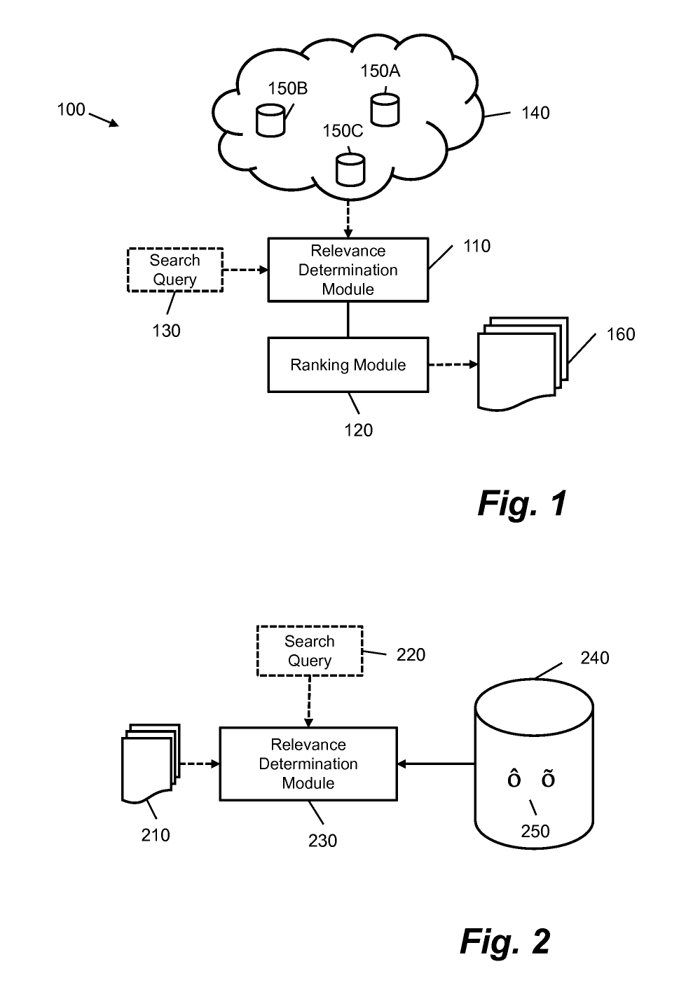

FIG. 1 is a simplified schematic diagram of a system 100 for determining the relevance of a document to a search query according to an example. The apparatus 100 comprises a relevance determination module 110 coupled to a ranking module 120. In FIG. 1 the relevance determination module 110 is shown receiving a search query 130. In the context of the present disclosure the search query 130 may comprise a string or strings of alphanumeric characters and symbols. The relevance determination module 110 is shown coupled to a network 140 where the network 140 comprises document repositories 150A, 150B and 150C. According to an example, the network 140 may represent a storage network comprising a series of interconnected document repositories where each document repository contains at least one document. In one example the storage network may be part of or coupled to a local area network (LAN) being accessed by one or more users accessing the documents stored in the network 140. In another example, the network 140 may represent the Internet, and document repositories 150A, 150B and 150C may represent one or more providers' servers or individual storage networks, each providing a plurality of storage repositories. In a further example the relevance determination module 110 may be connected to a single document repository or even be a standalone module connected to an interface for receiving documents, for example that may be sent to the module for relevance analysis.

According to an example, the relevance determination module 110 is arranged to receive documents from network 140. Relevance determination module 110 is arranged to identify at least one token from the search query 130. In the context of the present invention a token may be a substring in a string of symbols or alphanumeric characters which has been identified in the string as a substring (as opposed to, say, an arbitrary substring in the string). For example, the string w=wᵢ∥w₂ comprises a concatenation of tokens w₁ and w₂.

Alternatively a token may be a substring derived from a substring in the search query. For example, in the case where the search query 130 comprises words from a natural language, the relevance determination module may be arranged to identify a substring which is a synonym of the first string, by, for example, accessing an electronic thesaurus.

The relevance determination module 110 may be arranged to receive the search query 120 with at least one token and identify documents, from a corpus of documents stored in document repositories 150A, 150B and 150C, containing the at least one identified token. FIG. 1 shows document repositories 150A, 150B and 150C. However, the relevance determination module 110 maybe implemented as a standalone piece of software or hardware and be provided with a single document.

The relevance determination module 110 is arranged to use the Helmholtz score for an identified token, with respect to each document the token appears in, to determine the relevance of the document to the search query 120. In one case, the relevance determination module 110 may be arranged to initialize a list of “relevance scores” prior to using the Helmholtz scores that are indicative of the relevance of the at least one token to documents accessed from the document repositories 150A, 150B and 150C. The relevance determination module 110 may initially set all relevance scores for all stored documents to zero. According to an example, for a first token in the search query 130, the relevance determination module 110 calculates the relevance score for a document with the respective Helmholtz score representative of the relevance of the first token to that document. The relevance determination module 110 proceeds to compute, for a second token in the search query 120, a value indicative of the relevance of the token to the document then updates the relevance score accordingly. The relevance determination module 110 may iteratively compute values for all identifiable tokens in the string for the document and, for example, cumulatively add those values to its relevance score. The relevance score provides an indication of the relevance of the documents in repositories 150A, 150B and 150C to the search query 130. There are various ways, aside from addition, in which plural Helmholtz scores may be combined to form a relevance score.

In another example, the relevance determination may compute a plurality of Helmholtz scores for a token in the search query 120. For example, if a search query contained the term “house” the Helmholtz scores for “home”, and “residence” (a derivative of “home”, which may be determined from a thesaurus) may also be determined with respect to the corpus of documents. The relevance determination module may then take the Helmholtz score of the token to be the maximum of the Helmholtz scores of those strings, for example, or it may take the Helmholtz score of the combined number of occurrences of “house” and “home”. The Helmholtz score of the token may be used as the basis for determining the relevance of documents in the corpus to the search query as opposed to the original substring in the search query.

In another case, the relevance determination module may first determine all the Helmholtz scores for the token for each document prior to determining a relevance of the documents to the search query. The relevance determination module 110 may then compute the Helmholtz scores for a second token in the search query 120. The relevance determination module 110 may determine Helmholtz scores for all tokens that are identified in the search query 120 and determine an overall relevance of the documents to the search query 120. In a further example, the relevance determination module 110 may determine the Helmholtz scores for two or more tokens in parallel or the relevance of two or more documents may be determined as functions of the Helmholtz scores for respective tokens in parallel.

The relevance determination module 110 may determine the relevance of a document to a search query by cumulatively adding a Helmholtz score for each token, per document, to determine an overall relevance score of the document. In another example, other functions of Helmholtz scores or values derived from Helmholtz scores may be used to determine relevance scores. For example, it may be possible to determine the relevance of a document based on an average of the values for the tokens. Alternatively a relevance based on tokens with the highest (or lowest) Helmholtz scores for each document may be used instead of a cumulative score.

In an embodiment of the invention, relevance determination module 110 may be implemented in a standalone fashion where the module is arranged to identify a token, identify documents in a corpus of documents containing the token and determine the relevance of those documents to the search query. In particular, the relevance determination module 110 need not be connected to any other modules and can be implemented, for example, as a piece of a standalone software or hardware.

The relevance determination module 110 is shown in FIG. 1 to be connected to a ranking module 120. The ranking module 120 may access values indicative of the relevance of a document to the search query as determined by the relevance determination module 110 and is arranged rank the subset of documents in the corpus of documents containing at least one identifiable token of the search query according to their relevance to the search query. The determined scores may be used to sort a list of document from repositories 150A, 150B and 150C according to a ranking in decreasing (or increasing) order. This ranking may be performed using any standard sorting algorithm. In some cases where pre-sorting has occurred prior to determining the relevance of documents to the search query sorting algorithms may be used to sort the final list of relevance scores more efficiently. According to an example, the ranking module may return an index of documents as a ranking to users accessing document repositories 150A, 150B and 150C. FIG. 1 shows a set of documents 160 output by ranking module 120. The ranking module 120 may be arranged to output either a list of documents 160 relevant to the search query or, in another case where documents are indexed in their respective repositories, a list of indices of documents in order of relevance to the query.

In one case, the relevance determination module 110 may be arranged to rank documents during the determination of the relevance of the documents containing a token. For example, in the case where a large number of documents is to be ranked or where the documents and search query are large files, the relevance determination module 110 may rank documents by their relevance to an individual token after determining values indicating the relevance of the token to the document. The ranking module 120 can access the ranked documents, per-token and determine an overall ranking of the documents 160.

As described the relevance determination module 110 may determine the relevance of a document to the search query using the Helmholtz score. The Helmholtz score is a single value which provides an indication of whether a string appearing a certain number of times in a document (the document, being one of a number of documents) is an unexpected event. If a random variable is defined, Cₘ, which counts the number of times a substring appears m times in a document containing |D| strings where the substring appears K times across all documents, then aa processor may be arranged to determine an expectation of Cₘ as:

$$E ( {C}_{m} ) = ( \begin{matrix}K \\ m\end{matrix} ) \frac{1}{{N}^{m - 1}}$$

Where N is a ratio defined as, |C|/|D|, where |C| is the total number of strings across all documents. In practice this quantity can be exponentially small or large so a new quantity called the Helmholtz score can be calculated by a processor for a substring w in a document D, as

$$H ( w , D ) = - \frac{1}{m} log [ ( \begin{matrix}K \\ m\end{matrix} ) \frac{1}{{N}^{m - 1}} ] \qquad ( 1 )$$

### Here,

$$( \begin{matrix}K \\ m\end{matrix} )$$

is the binomial coefficient. The Helmholtz score provides an indication that the substring w appearing m times in a particular document out of the set of documents, where w is known to appear a certain number of times is a likely or unlikely event. Consequently if this value is particularly large (or small) it indicates that a particular document is relevant for that substring. Notice, that a document may contain a very large number of instances of the substring w but still be irrelevant because the document is very long or because the total number of occurrences of the substring across all the documents is very large, in which case it may not be unexpected that the substring occur a large number of times in a single document.

The relevance determination module 110 may be arranged to determine the number of occurrences of a token in a subset of documents known to contain the token, for example, as received from the network 140, and compute, based on the number of occurrences of the token for each document, the Helmholtz score for that token in the document as shown in equation (1). Based on the Helmholtz score, the relevance determination module 110 may determine a relevance score for the token in relation to each document. In one case, the relevance determination module 110 may determine the subset of documents which contain the token. Similarly, the number of occurrences of a token across all documents and for each document in the subset may be provided from the network 140 or may be determined by the relevance determination module 110.

According to an example, the relevance determination module 110 is arranged to determine the relevance of a document according to a value for the or each token where the value is set equal to the Helmholtz score if the Helmholtz score is greater than a threshold and wherein the value is equal to the threshold if the Helmholtz score is less than threshold. This provides a means of filtering documents which are of little relevance to a token in the search query 130. In most cases, the tokens with Helmholtz scores smaller or equal to the threshold make a small contribution to the relevance score of a document but these tokens may still contribute to the identification of relevant documents. For example, if a document contains only one of the tokens from a query then this document may still be considered relevant. For example, a document corpus may comprise a set of documents which only contain one token from a query. Alternatively, the tokens with values smaller or equal to the threshold may be deemed not to contribute to the relevance score at all.

Similarly, the relevance determination module 110 may be arranged to identify documents of low relevance to a search query by identifying that the Helmholtz scores for that document are below a threshold value for all tokens in a search query and identify the document as such, when returning scores to the ranking module 120. In particular, documents which have been identified as having a sub-threshold relevance for all substrings could be removed from a ranking altogether, for example where a searcher does not wish to receive a large number of documents for their query. In the case where the number of documents is large, the threshold may be set appropriately to remove “noise” prior to any ranking algorithm being executed across the documents by the ranking module 120. In a further example, a searcher may be able to increment a threshold to progressively filter results of lower relevance to their search query.

Values based on the Helmholtz scores, indicative of the relevance of a token to a document may also be weighted. For example, relevance determination module may be arranged to scale the Helmholtz scores by at least one of a first factor where the factor is indicative of the importance of the substring to the search query and a second factor indicative of the importance of the substring to the document. In one example where scores are determined as a sum of values indicative of the relevance of the substrings, the values may be scaled by the respective weightings to increase the values for particular documents or substrings and increase the respective relevance score for the document. Weightings can also be used as normalisation constants for each document by computing evaluating a norm function on the weightings. For example, the Euclidean, Manhattan, Maximum, p-norm or any other norm function of the vector comprising the Helmholtz scores for each substring, for that document may be used to generate normalisation constants.

The relevance determination module 110 may be arranged to use an index, where the index indicates which documents in the corpus of documents contain at least one token. In the simplest example the index provides a list of tokens and, for each token, identifies the corresponding documents containing those tokens. The relevance determination module 110 may be arranged to construct the index prior to receiving any search query and before using or computing any Helmholtz scores. The index may comprise additional information such as the number of occurrences of tokens within documents held in the corpus of documents. Additionally the index may provide information on substrings related to (or derivable from) the token. In this case, the index may provide an indication of the occurrences of the token through the document corpus and also of the substring with capital letters removed, throughout the document corpus. Data stored in the index may be used in the computation of the Helmholtz scores as shown in equation (1).

FIG. 2 is a simplified schematic block diagram showing an apparatus 200 for determining the relevance of a document in a corpus of documents 210 to a search query 220, according to an example. In FIG. 2 the relevance determination module 230 is shown to have access to the corpus of documents 210 and also storage 240 and to receive the search query 220. The relevance determination module 230 is arranged to access one or more stored pre-computed Helmholtz scores 250 {Hᵢ} held in storage 240. In the example shown in FIG. 2, the pre-computed Helmholtz scores 250 are computed for the corpus of documents 210. In this case, the relevance determination module 230 is arranged, for each document in the subset 210 and for each token in the search query 220 to determine a number of occurrences of a substring in a document, access the pre-determined Helmholtz score and using the precomputed Helmholtz score, determine the relevance of documents 210 to the search query.

In one case the relevance determination module 230 may be arranged to compare the Helmholtz scores 250 to a threshold value and determine a value indicative of the relevance of a token to the document based on the threshold value. In another example, the comparison of the Helmholtz scores 250 to a threshold value may also be pre-computed, in which case the relevance determination module 230 may access the values indicating the relevance of a substring to a document directly without any further computation and determine a respective relevance score as a function of the computed values. While pre-computation allows for a more efficient run-time execution than real-time computation of Helmholtz scores this approach requires increased storage to be readily accessible to the relevance determination module 230.

In one example, the relevance determination module 230 may leverage spare storage capacity in storage 240 between queries. For example, relevance determination module 230 may determine a first set of Helmholtz scores for a first query and store these in storage 240 for reuse in a second search query in the case that the second search query contains tokens that appeared in the first search query. In particular, the relevance determination module 230 may combine pre-computed values with newly computed values to avoid unnecessary re-computation of values corresponding to the same token. In this way, a large volume of search queries may be efficiently processed without the need for re-computing Helmholtz scores per query. Additionally, the pre-computed Helmholtz scores 250 may also be scaled by pre-computed weightings indicating the importance of a token to a document.

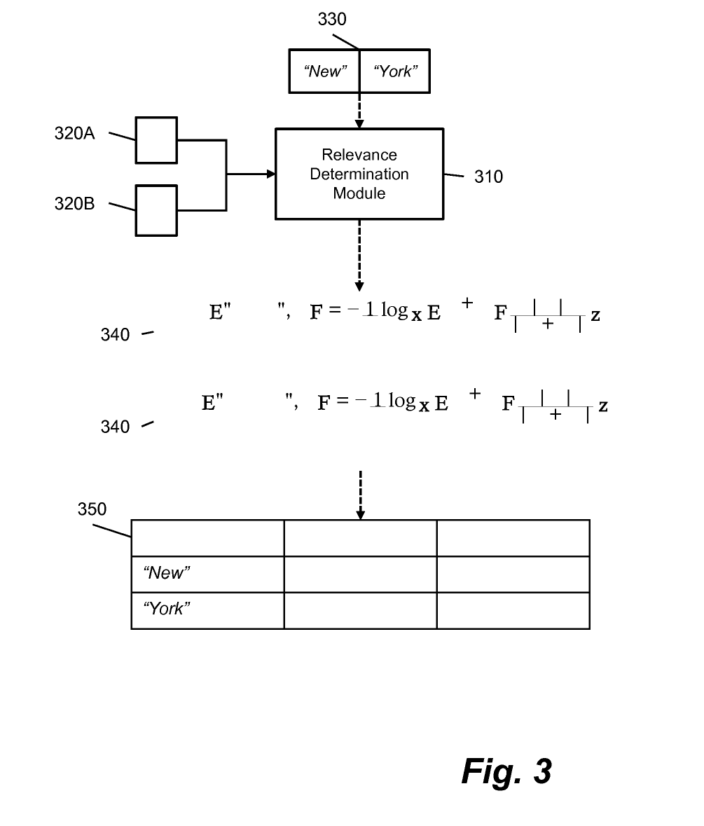

FIG. 3 shows an example of the computations carried out by a relevance determination module 310 to determine the relevance scores of a corpus of documents comprising two documents D₁ 320A and D₂ 320B. In the example shown in FIG. 3, relevance determination module 310 receives a search query 330, in this case comprising two tokens “New” and “York”. The relevance determination module 310 is arranged to determine the number of occurrences of the tokens “New” and “York” in each of documents 320A and 320B and compute, or retrieve in the case they have been pre-computed, Helmholtz scores 340 for each token and for each document. In the example shown in FIG. 3, the documents D₁ and D₂ comprise |D₁| and |D₂| tokens respectively. The token “New” appears n₁ times in D₁ and n₂ times in D₂. Similarly “York” appears m₁ times in D₁ and m₂ times in D₂. Relevance determination module 310 computes four values 340—two for each token, corresponding to each document. Following equation (1) above, the Helmholtz scores for “New” are computed as

$$H ( “ New ” , {D}_{i} ) = - \frac{1}{{n}_{i}} log [ ( \begin{matrix}{n}_{1} + {n}_{2} \\ {n}_{i}\end{matrix} ) \frac{{\vert {D}_{i} \vert}^{{n}_{i} - 1}}{{\vert {D}_{1} + {D}_{2} \vert}^{{n}_{i} - 1}} ]$$

Similarly Helmholtz scores can be computed for “York”.

Helmholtz scores also can be determined for the additional identifiable token comprising the string “New York”. Although not shown in FIG. 3, including this substring may be prudent if the phrase “New York” is deemed to be more important than either or both of “New” and “York” alone. Equally, another substring “York New” may be included, if word order is deemed not to be important. The choice of which permutations and combinations of words to use can be user-configured or may be a function of the process being applied. In the latter case, for instance if all possible word combinations are included, in any word order, then weighting may be applied as described herein to identify, if any, the more important word combinations. In any event, selection of the word combinations, referred to herein as identifiable substrings, may be performed as a pre-processing step of examples herein.

The relevance determination module 310 can compute values R₁ and R₂ for token “New” and values S₁ and S₂ for token “York” for documents D₁ and D₂, respectively, indicating the relevance documents D₁ and D₂ to those tokens. These values, as described in relation to FIGS. 1 and 2 are based on the Helmholtz scores and may be compared to a threshold value. Furthermore, the values may be weighted, for example, if “York” was a higher priority token than “New” to the search query 330, the values in table 350 could be weighted to reflect this. In one example, the relevance scores of each document 320A and 320B may be determined as a sum of the values. In the example shown in FIG. 3, D₁ would have a relevance score of R₁+S₁ and D₂ would have a relevance score of R₂+S₂. According to an example, ranking module 120 in FIG. 1 can compare the two scores to determine if R₁+S₁ is greater or less than R₂+S₂. In another case, the relevance determination module may determine the relevance score as the maximum of values R₁ and R₂ for the token “New” and the maximum of values S₁ and S₂ for the token “York”.

In a second example, the search query 330 comprises three tokens “New”, “York” and “Café”. In this case, the identifiable tokens “New”, “York”, “Café”, “New York”, “York Café” and “New York Café”. The intention of a searcher may have been to identify a café in New York in a collection of documents. In such a case it may be useful to the searcher to make use of weightings for the search. For example, one weighting could be used to indicate that those documents containing “New York” and “New York Café” are more important than those just containing the tokens of those strings—namely “New” and “York” in isolation or the token “York Café”. In that case, the values indicating the relevance of “New York” and “New York Café” can be weighted giving documents containing those strings a greater relevance score than those containing only “New”, only “York” and “York Café”, for example. Indeed, in order to avoid search results from returning documents relating to new cafés in the English city of York, the substring “York Café” may be given a weighting to reflect its irrelevance to the search query. In another example, more elaborate functions may be used than functions which assign greater or less weightings to tokens.

In an alternative case, a weighting assigned to tokens may be based on, for example, machine-learning. For example, if a weighting of certain tokens appears to produce improved results for searchers, that weighting may be recorded and automatically applied to future queries for those tokens.

In a further example, valid tokens may be derived from one or more substrings of a query and, in particular, need not be a contiguous sequence of characters appearing in a query. For example, “Café, New York” may be a valid token of a search query containing the sequence of substrings “the café in New York”. In one case, words may be transposed in a query with no effect on the final outcome. In one implementation swapping the order of substrings which from the token for which a Helmholtz score is computed has no effect on determining the relevance. For example a token “New York” is the same as “York New”. In that case the most relevant documents to a search query will be that which contains tokens all permutations of substrings contained in the tokens. In another implementation a searcher or the system 100 may identify that substring order in a token is important to the identification of relevant documents. In particular, the documents identified as relevant for one substring order may not be identical to those identified for an alternative substring order in a token.

Alternatively, the searcher may be accessing a number of separate document repositories 150A, 150B and 150C, where for example, 150A contains web pages related to “New York”, 150B contains downloaded information, for example, from tourist information boards and 150C contains map data. In that case, the values indicating relevance of the documents to the search query for documents from for example repository 150A and 150B may be weighted to reflect that they are of greater importance than those from the repository 150C.

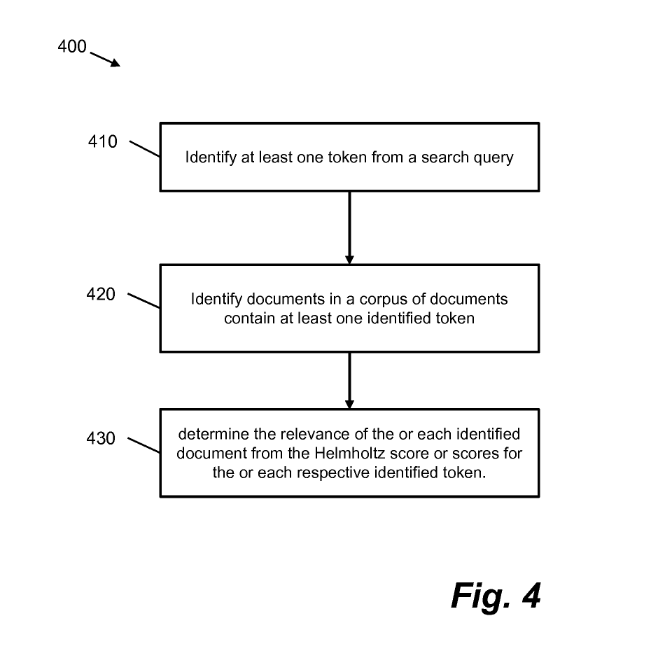

FIG. 4 is a flow diagram of a method 400 of identifying documents for a search query according to an example. The method 400 may be implemented on apparatus 100 and 200 shown in FIGS. 1 and 2. At step 410 at least one token in a search query is identified from the search query. Step 410 may be implemented on a relevance determination module such as relevance determination module 110 accessing a network 140 and receiving a search query 130 as shown in FIG. 1. The search query can be an automatically generated query or may be generated by a user accessing stored documents in the network 140. The search query may additionally comprise user preferences regarding the search, such as, for example, specifying one or more weighting preferences as described in relation to FIGS. 1 to 3.

At step 420, documents in a corpus of documents containing at least one identified token are identified. The steps of identifying at least one token in the search query and identifying the documents containing the at least one identified token may be carried out at run-time or may be carried out in a pre-computation phase. Alternatively a system implementing method 400 such as a relevance determination module 110 as shown in FIG. 1 may use an index. The index may indicate which documents in the corpus of documents contain at least one token. In particular, an index may provide an indication of which tokens appear in which documents in the corpus of documents. In another case a system of device implementing the method 400 may receive an indication of a token in a search query without carrying out any further determination or identification.

At step 430 the Helmholtz scores of the or each token are used to determine the relevance of the document to the search query. In one case a device implementing method 400 such as relevance determination module 110 may determine the relevance as a relevance score, calculated, at least in part from Helmholtz scores (equation (1)) of tokens contained in the search query. Alternatively method 400 may be implemented on a device which has been provided with values from storage in the case that Helmholtz scores have been pre-computed.

Determining a relevance of a document as a relevance score may comprise computing a function at a relevance determination module 110 comprising determining the combined total of Helmholtz scores for each token. The relevance determination module 110 may compute or access a Helmholtz score for a token and document and add the value to the cumulative total for that document. In an alternative approach, the relevance determination module may be arranged to carry out a computation and send the result to an accumulator (not shown) which determines the final relevance scores for each document.

In a case where the values indicative of the relevance of the documents to each substring in the query have been pre-computed, the method 400 may be implemented without ever accessing the documents—it may be sufficient to provide a document index and pre-computed values for each document, for each token. In that case, step 430 can be implemented by accessing the indexes of the documents and the pre-computed values and determining the relevance for each index.

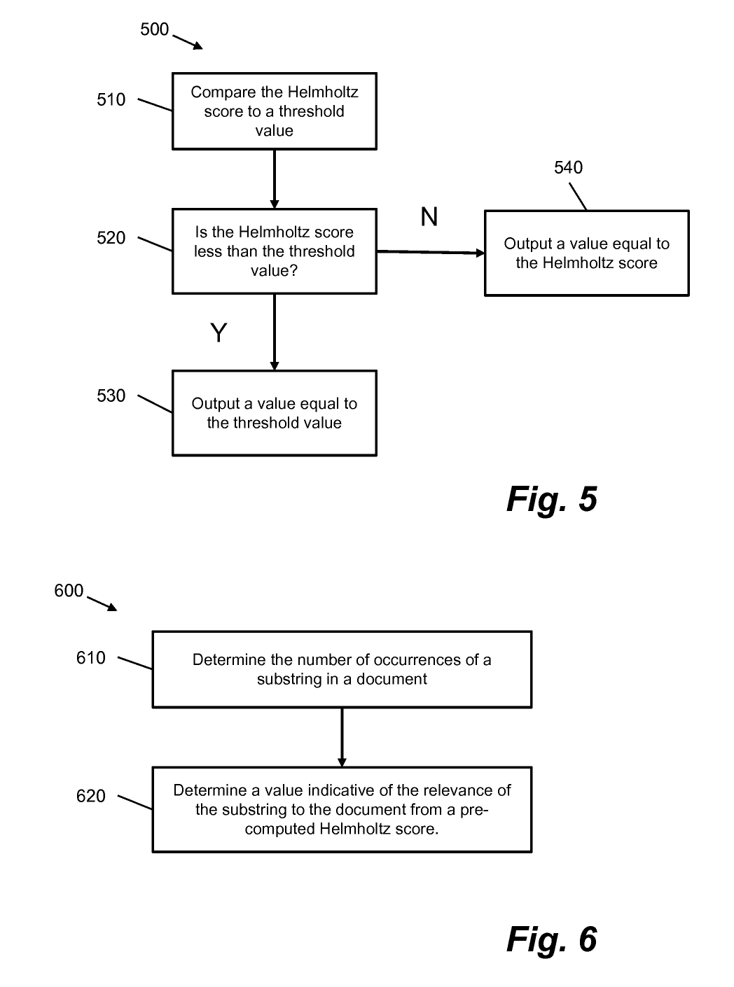

FIG. 5 is a flow diagram showing a method 500 of determining a value based on a comparison of the Helmholtz score of a token for a document with a threshold value. The method 500 shown in FIG. 5 may be used in conjunction with the previous methods and apparatus described herein. In particular method 500 may for example be implemented on apparatus 100 by relevance determination module 110. Alternatively, method 500 may be implemented by a filter specifically executing code to compare values determined by the relevance determination module 110.

At step 510 the Helmholtz score of a token is compared to a threshold value. The threshold is an experimental threshold which is used to differentiate between important and non-important tokens in the search query, to a particular document. At step 520 a determination is made if the Helmholtz score is less than the threshold value. If “yes”, then at step 530, a value is output equal to the threshold value. If “no” then at step 540, a value is output equal to the Helmholtz score. Weightings, as described in relation to previous embodiments may be applied to the Helmholtz scores before or after a comparison with a threshold value has taken place. It may be unnecessary to compare the values to a threshold in the case that a Helmholtz score is weighted for a document, where the weight is a low value indicating that a token is of low importance to a document. In another case at step 540, if it is determined that the Helmholtz score already exceeds the threshold, a weighting can be applied after the comparison. This can be used to further differentiate the more important documents or tokens in the query from the less important ones.

500 FIG. 5. FIG. 6 is a flow diagram showing a method 600 of determining the relevance of a document to a search query from pre-computed Helmholtz scores, according to an example. The method 600 shown in FIG. 6 may be implemented on the apparatus 200 shown in FIG. 2, which illustrates a relevance determination module 230 accessing a set of pre-determined Helmholtz scores. At step 610 the number of occurrences of a token in a document is determined. As in previous examples, this may be a quantity provided to the entity implementing the method 600, for example, from a document repository providing data on the documents it is storing. Alternatively, the entity implementing the method, such as document access module 230 may count the number of occurrences of the token itself. In another example the number of occurrences of a token may be determined from an index. At step 620 a value indicative of the relevance of the token to the document is determined, based on a pre-computed Helmholtz score for that document. The Helmholtz score may have been pre-computed during a pre-computation phase prior to any search query being received at the relevance determination module 230, in the case that the method is being implemented on apparatus 200. Alternatively, the pre-computed Helmholtz score may have been computed as a result of a previous search query which contained the substring, in which case the relevance determination module may access the stored pre-computed value.

Aside from selecting tokens, further pre-processing or conditioning steps may be applied to a search before starting the relevance determination procedures. For example, all letters may be made lower case, non-alphanumeric characters may be removed, punctuation may be removed (although some punctuation may be deemed pertinent by some search algorithms) and word-stemming and/or other known string and word processing techniques may be applied, for example, in order to render a search procedure and/or its results more consistent. Such techniques are generally known in the art of searching and will not be described herein in further detail.

The systems and methods described in the examples have the advantages of providing a means of efficiently determining the relevance of a collection of documents to a search query and providing the searcher with a ranking of those document according to their relevance. The systems and methods do not rely on any pre-clustering of documents with and can respond to a user's search query in real time. Advantageously, the methods can be used in an environment in which pre-processing is not available prior to the time when a user makes a query.

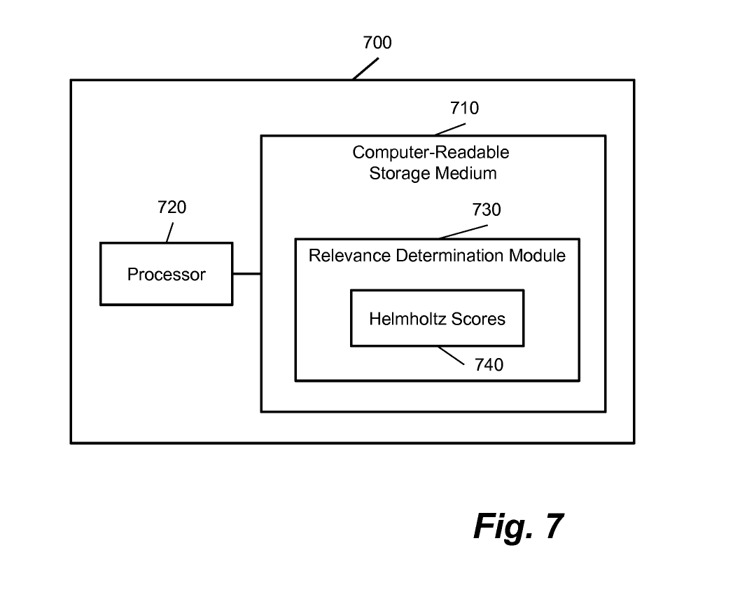

Certain methods and systems as described herein may be implemented by a processor that processes program code that is retrieved from a non-transitory storage medium. FIG. 7 shows an example 700 of a device comprising a machine-readable storage medium 710 coupled to a processor 720. Machine-readable media 710 can be any media that can contain, store, or maintain programs and data for use by or in connection with an instruction execution system. Machine-readable media can comprise any one of many physical media such as, for example, electronic, magnetic, optical, electromagnetic, or semiconductor media. More specific examples of suitable machine-readable media include, but are not limited to, a hard drive, a random access memory (RAM), a read-only memory (ROM), an erasable programmable read-only memory, or a portable disc. In FIG. 7, the machine-readable storage medium comprises program code to effect a relevance determination module 730 and Helmholtz scores 740 as described in the foregoing examples herein.

Similarly, it should be understood that the relevance determination module 730 may in practice be alternatively provided by a single chip or integrated circuit or plural chips or integrated circuits, optionally provided as a chipset, an application-specific integrated circuit (ASIC), field-programmable gate array (FPGA), etc. The chip or chips may comprise circuitry (as well as possibly firmware) for embodying at least document access module as described above, which are configurable so as to operate in accordance with the described examples. In this regard, the described examples may be implemented at least in part by computer program code stored in (non-transitory) memory and executable by the processor, or by hardware, or by a combination of tangibly stored code and hardware (and tangibly stored firmware).

The preceding description has been presented to illustrate and describe examples of the principles described. This description is not intended to be exhaustive or to limit these principles to any precise form disclosed. Many modifications and variations are possible in light of the above teaching.

What is claimed is:

1. A method of identifying a relevance to a search query of at least one document in a corpus of documents, comprising:
identifying at least one document in a corpus of documents that contains at least one token, which is identified from a search query; and
determining the relevance to the search query of the or each identified document from the Helmholtz score or scores for the or each respective identified token.

2. The method of claim 1 wherein a token comprises a string or a substring of the search query, or is derived from a string or a substring of the search query.

3. The method of any one of the preceding claims comprising determining, for the or each identified token, a value, which is equal to the Helmholtz score if the Helmholtz score is greater than a threshold or is equal to the threshold if the Helmholtz score is less than the threshold, and using the respective value or values to determine the relevance to the search query of the or each identified document.

4. The method of any one of the preceding claims comprising using an index to indicate which document(s) in the corpus of documents contain at least one token.

5. The method of any one of the preceding claims, comprising, for the or each identified document, computing a Helmholtz score for the or each respective identified token.

6. The method of any one of the preceding claims, comprising, for the or each identified document, using a pre-computed Helmholtz score for the or each respective identified token.

7. The method of any one of the preceding claims wherein a subset of identified documents, in the corpus of documents, each containing at least one identified token, are ranked according to their relevance to the search query.

8. The method of any one of claims 1 to 7, wherein, for any identified document which contains more than one identified token, the relevance to the search query is determined by combining the respective Helmholtz scores.

9. An apparatus comprising a relevance determination module arranged to:
identify at least one token from a search query;
identify at least one document in a corpus of documents containing at least one identified token, which is identified from a search query; and
determine the relevance to the search query of the or each identified document from the Helmholtz score or score for the or each respective identified token.

10. The apparatus according to claim 9 wherein a token comprises a string or a substring of the search query or is derived from a string or a substring of the search query.

11. The apparatus of claims 9 to 10 wherein the relevance determination module is arranged to determine for the or each token, a value which is equal to the Helmholtz score if the Helmholtz score is greater than a threshold and is equal to the threshold if the Helmholtz score is less than the threshold and using the respective value or values to determine the relevance to the search query of the or each identified document.

12. The apparatus of claims 9 to 11 wherein the relevance determination module is arranged to use an index, the index indicating which document(s) in the corpus of documents contain at least one token.

13. The apparatus of claims 9 to 12 wherein relevance determination module is arranged, for the or each identified document, to compute a Helmholtz score for the or each respective identified token

14. The apparatus of claims 9 to 12 wherein the relevance determination module is arranged, for the or each identified document, to use a pre-computed Helmholtz score for the or each respective identified token.

15. The apparatus of claims 9 to 14 further comprising a ranking module arranged to rank a subset of identified documents in the corpus of documents each containing at least one identified token of the search query according to their relevance to the search query.

16. The apparatus of any one of claims 9 to 15, wherein for any identified document which contains more than one identifiable token, the relevance determination module is arranged to determine the relevance of the document to the search query by combining the respective Helmholtz scores.

17. A non-transitory computer-readable storage medium storing instructions that, when executed by one or more processors, cause the one or more processors to:
identify at least one document in a corpus of documents that contains at least one token, which is identified from a search query; and
determine the relevance to the search query of the or each identified document from the Helmholtz score or score for the or each respective identified token.
